(19) United States
(12) Patent Application Publication
(10) Pub. No.: US 2022/0129146 A1
(43) Pub. Date: Apr. 28, 2022

(54) METHOD FOR CONTROLLING A COMPUTER DEVICE FOR ENTERING A PERSONAL CODE

(71) Applicant: Orange, Issy-les-Moulineaux (FR)

(72) Inventors: Xavier Leleu, Chatillon Cedex (FR); Zougane Haffez, Chatillon Cedex (FR)

(21) Appl. No.: 17/429,928

(22) PCT Filed: Jan. 31, 2020
(86) PCT No.: PCT/FR2020/050160

§ 371 Date: Aug. 10, 2021

(30) Foreign Application Priority Data
Feb. 12, 2019 (FR) 1901378

(51) Int. Cl. G06F 3/04883; G06F 3/0482; G06F 21/31

(52) U.S. Cl. CPC G06F 3/04883; G06F 21/31; G06F 3/0482

(57) ABSTRACT

A method for controlling a computer device comprising a graphic user interface is disclosed. The method comprises implementation, by a data-processing module, of: requesting a user to enter a code on the graphic user interface by means of a virtual keyboard, comprising randomly arranged elements, the code consisting of a sequence of elements of the virtual keyboard; for an element of the sequence constituting the code: if a first type of gesture performed by the user on the graphic user interface is detected, changing a current element of a list of possible elements of the virtual keyboard corresponding respectively to one of the elements of the virtual keyboard; if a second type of gesture, different from the first type of gesture, performed by the user on the user interface is detected, validating the current element as an element of the sequence constituting the code.

### CROSS-REFERENCE TO RELATED APPLICATIONS

This application is filed under 35 U.S.C. § 371 as the U.S. National Phase of Application No. PCT/FR2020/050160 entitled “METHOD FOR CONTROLLING A COMPUTER DEVICE FOR ENTERING A PERSONAL CODE” and filed Jan. 31, 2020, and which claims priority to FR 1901378 filed Feb. 12, 2019, each of which is incorporated by reference in its entirety.

### BACKGROUND

### Field

The present development relates to the field of entering a personal code via a computing equipment in order to access a service.

It relates more precisely to a method for controlling such an equipment in a screen reading mode.

### Description of the Related Technology

Screen reading software designed for the blind or for those with very poor sight or even illiterate people is nowadays known. Reference will be made in particular to VoiceOver, developed by Apple and integrated into the iOS and MacOSX operating systems.

These pieces of software read, through voice synthesis, what is displayed on the screen of a computing equipment such as a computer or a mobile terminal, and make it possible to interact therewith by way of a certain number of predetermined commands.

It will thus be understood that, when such a piece of software is activated, “ordinary” commands are no longer necessarily active. An “ordinary command” is understood to mean a conventional gesture by way of which the user interacts with his screen. For example, on a mobile terminal with a touch interface, such as a smartphone, “tapping” an object normally selects it (for example tapping the icon of an application launches it), but when the screen reading software is activated, the same single tap on an object allows the user to listen to its description (for example the name of the application whose icon is tapped), and a double tap or long tap leads to confirmation thereof.

These mechanisms thus allow a user, in technical terms, to completely control his equipment without using the screen.

A difficulty is however observed when using virtual keypads, in particular for entering a code.

Indeed, it is very well known to offer keypads containing elements arranged in a random manner (often additionally with dummy elements such as blank cells), typically a 3×4 keypad with numbers from 0 to 9 and two blank cells, in order to enter a code allowing access to a sensitive service, for example a bank account.

The purpose of such a virtual keypad is to prevent keylogger/mouselogger attacks: if the user were to enter the code using his normal keypad, a keylogger would make it possible to ascertain the sequence of taps that are made and to deduce the code therefrom. As soon as a virtual keypad is used, the keylogger is only able to ascertain the location of the selected elements; a screen capture would be required to recover the code.

Although such virtual keypads are satisfactory from the viewpoint of computer security, they prove difficult to use with screen reading software.

Indeed, although it is possible to use them under a screen reader on the condition that the user has taken a few precautions (using a headset or earphones in order to avoid the entered code from being heard by everyone, and possibly activating a security mode in which the screen is turned off so as to avoid being looked at by others who are not of poor sight), the jumbling of the elements that are presented means that the user has to test the elements in succession (i.e. listen to their description) in order to discover their position and that of any dummy elements. After selecting a digit of the code to be entered through the appropriate gesture (for example a double tap), his only choice is to restart unless he has managed to memorize, in the best-case scenario, those that have already been tested to ascertain whether the next digit to be provided is located there.

There is a strong chance that the user will end up losing track with his code (he does not necessarily know the point he is at in terms of entering it), and if he makes a mistake, the majority of virtual keypads then modify the layout of their elements for a new entry, meaning that the whole mental sequence has to be restarted in this case.

It would therefore be desirable to have a novel solution for using a virtual keypad with screen reading software that is easier and more ergonomic, without otherwise decreasing security.

### SUMMARY OF CERTAIN INVENTIVE ASPECTS

The present development thus relates, according to a first aspect, to a method for controlling a computing equipment comprising a graphical user interface, the method being characterized in that it comprises implementing steps of:
a) requesting that the user enter a code on the graphical user interface by way of a virtual keypad, said code consisting of a sequence of elements of said virtual keypad;
b) for an element of the sequence forming said code:
   if a gesture of a first type performed by the user on the graphical user interface is detected, changing a current element from a list of possible elements associated with the virtual keypad;
   if a gesture of a second type, different from the first type of gesture, performed by the user on the user interface is detected, confirming the current element as the element of said sequence forming said code.

The list of possible elements, able to be manipulated with just two types of gesture, makes it possible to use the virtual keypad in screen reading mode without any difficulty in finding the often random position of the elements. The entry of a code is thus made much easier for those with poor sight or illiterate people.

More precisely, the virtual keypad comprises elements arranged in a random manner. Indeed, a random arrangement increases security by disrupting keyloggers, without having any negative impact on the ergonomics of the present method, since the list of possible elements remains the same regardless of the position of the elements of the virtual keypad.

More precisely, an element from the list associated with the virtual keypad corresponds to one of the elements of the virtual keypad.

According to other advantageous and non-limiting features:
said graphical interface is a touchscreen, said first and second types being tapping gestures (this is a type of interface highly suited to virtual keypads and to various gestures, making it even easier to perform the entry in screen reading mode);
the first type of gesture is a swipe and the second type of gesture is a double tap (such gestures are particularly intuitive);
with the computing equipment furthermore comprising an audio output, step (b) comprises vocally describing, on the audio output, an action implemented following the detection of a first or second type of gesture (the audio description allows a user, who may be completely blind, to ascertain exactly what is happening on the screen and to implement the present method without any difficulty);
step (a) comprises vocally describing, on the audio output, said list of possible elements of said virtual keypad (describing the list of possible elements in advance allows the user to anticipate the position of the elements forming his code and to save time. He thus does not have to look for anything);
the virtual keypad comprises at least one element that cannot form part of the code, said list of possible elements of said virtual keypad comprising all of the elements of the virtual keypad that are able to form part of the code (similarly, the presence of dummy elements increases security by disrupting keyloggers, without having any negative impact on the ergonomics of the present method, since the list of possible elements does not contain any such dummy elements);
said list of possible elements of said virtual keypad furthermore comprises a delete element, confirmation of which causes a return to the previous element of the sequence forming the code (the addition of this delete element allows the user to easily correct an entry mistake while still remaining in screen reading mode);
the method furthermore comprises, after each element of the sequence forming the code has been selected, a step (c) of submitting the code (this makes it possible to confirm the code and to effectively use it for example in order to authenticate the user).

According to a second aspect, the development relates to a computing equipment comprising a data processing module and a graphical user interface, characterized in that the data processing module is configured so as to:
request that the user enter a code on the graphical user interface by way of a virtual keypad, said code consisting of a sequence of elements of said virtual keypad;
for an element of the sequence forming said code:
   either detect a gesture of a first type performed by the user on the graphical user interface, and then change a current element from a list of possible elements of said virtual keypad;
   or detect a gesture of a second type, different from the first type of gesture, performed by the user on the user interface, and then confirm the current element as the element of said sequence forming said code.

More precisely, the virtual keypad comprises elements arranged in a random manner.

More precisely, an element from the list associated with the virtual keypad corresponds to one of the elements of the virtual keypad.

According to a third and a fourth aspect, the development relates to a computer program product comprising code instructions for executing a method according to the first aspect for controlling a computing equipment when said program is executed by a computer; and a storage medium able to be read by a computing equipment and on which a computer program product comprises code instructions for executing a method according to the first aspect for controlling a computing equipment.

### BRIEF DESCRIPTION OF THE DRAWINGS

Other features and advantages of the present development will become apparent upon reading the following description of one particular embodiment. This description will be given with reference to the appended figures:

FIG. 1 shows a diagram of a general network architecture for implementing the development;

FIG. 2 shows one example of a virtual keypad for entering a code;

FIG. 3 is a flowchart illustrating the implementation of one particular embodiment of the proposed method.

### DETAILED DESCRIPTION OF CERTAIN ILLUSTRATIVE EMBODIMENTS

### Architecture

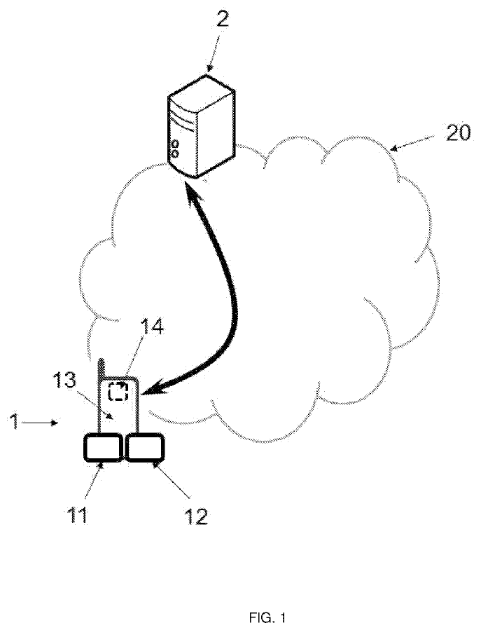

With reference to FIG. 1, the development proposes a method for controlling a computing equipment 1, intended in particular for the entry of a code, typically a personal code associated with a user seeking to access a service, in particular a sensitive service (for example consulting a bank account, opening a messaging service, modifying personal information or confidentiality settings, etc.). Said method is preferably implemented directly within an application dedicated to said service, for example a banking application, and to this end the service is typically implemented by a remote server 2, to which the computing equipment 1 may be connected by a network 20 such as the Internet.

It will be understood that, as an alternative, the service may very well be implemented directly by the operating system of said computing equipment 1 (for example in order to modify confidentiality settings, which requires the entry of a code), and no connection to a network 20 is then necessary.

In the remainder of the present description, the example will be taken of entering a personal code in order to access a banking service via a dedicated application, but it will be understood that the present development is not limited to any context or any particular use.

The computing equipment 1 may be of any type, in particular a mobile terminal such as a smartphone or touchscreen tablet, but also a personal computer, a public terminal, etc. It comprises a data processing module 11 (a processor), advantageously a data storage module 12 (a memory), and a graphical user interface 13 (HMI) comprising for example entry means and display means. In one particular embodiment, the graphical user interface 13 is a touchscreen (which combines the entry and display functions), but it may very well be an ordinary screen coupled to a pointing device, such as a mouse or a trackpad, and/or a keypad.

Advantageously, the terminal 1 may furthermore comprise an audio output 14, which may be both a physical output (integrated loudspeaker, headset jack, etc.) and a virtual output (for example a wireless connection, in particular Bluetooth, with an audio peripheral such as a connected speaker).

### Virtual Keypad

The present method is preferably intended to be implemented in a screen reading mode (often presented as a mode for “accessibility for those with poor sight”), i.e. when screen reading software is activated.

To this end, the present method may make it possible to control the computing equipment 1 in addition or as an alternative to a “conventional” or “ordinary” control mode (see further below), i.e. implementing the screen reading mode may deactivate said conventional control mode where applicable.

Generally speaking, the screen reading software may be integrated into the operating system of the computing equipment 1. In such a case, although the code entry may be implemented in a dedicated application, this application may call the screen reading software of the OS and/or implement its own screen reading software. For example, the screen reading software of the OS may be called only to vocalize elements indicated by the dedicated application.

The presence of an audio output 14 is particularly appropriate in the case of implementing screen reading software, since such software emits acoustic messages on the audio output 14.

Conventionally, the method starts with a step (a) of requesting that the user enter a code on the graphical user interface 13 by way of a virtual keypad, said code consisting of a sequence of elements of said virtual keypad. In general, this step (a) for this purpose requires the display of the virtual keypad by the graphical interface 13 with a view to the user entering the code on this virtual keypad, but, as will be seen further below, the display functions of the graphical user interface 13 may possibly be deactivated for various reasons, without this changing anything with regard to the present method.

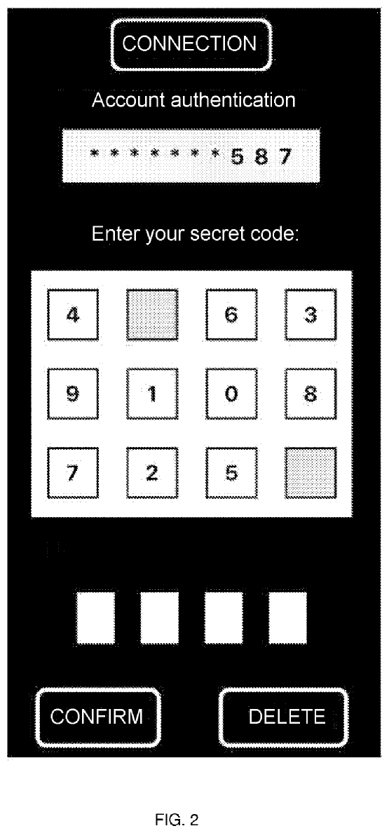

A virtual keypad is understood to mean a software object allowing the user to make an entry in the absence of a physical keypad, as shown for example by FIG. 2. More precisely, the virtual keypad, when it is displayed on the graphical interface 13, defines a set of virtual keys each associated with an “element” of the keypad, each element generally being an alphanumeric character, but it will be understood that some elements of the virtual keypad may be non-alphanumeric characters (for example punctuation marks), symbols (for example mathematical operators), ideograms (Asian characters), other pictograms (in particular emoticons) or the like (purely functional elements such as shift key, or “dummy” elements, see further below).

In a conventional control mode, the user selects an element of the virtual keypad as if he were pressing the corresponding virtual key, by tapping (in the case of a touch interface) the associated zone or by moving a pointer there (a mouse for example).

Smartphone mobile terminals have predetermined virtual keypads implemented by the OS, for example an azerty keypad, generally for entering text. Such a virtual keypad is intended to be a full substitute for a physical keypad.

In the context of the present method, said virtual keypad displayed in step (a) is a virtual keypad dedicated to entering the code rather than the basic virtual keypad of the computing equipment 1, i.e. a virtual keypad often implemented by the corresponding application, and having a reduced number of elements (the purpose of such a keypad is only to enter the code, and not other uses such as entering a message). The keypad is typically alphanumeric, or even only numeric (i.e. numbers from 0 to 9), since said code is often only numeric, for example a four-digit code. This does not rule out the virtual keypad being able to comprise at least one element that cannot form part of the code, typically a dummy element. A dummy element is understood to mean a key of the keypad not associated with any character, in other words that is unselectable. A dummy element is typically a blank cell intended to complicate any spying on the keypad. In one particular embodiment, said virtual keypad consists only of elements that are able to form part of the code and of dummy elements, in particular the numbers from 0 to 9 and two, five or six dummy elements, so as to allow, respectively, 3×4 (as in the example of FIG. 2), 3×5 or 4×4 grids.

Another specific feature of virtual keypads dedicated to entering a code is that the elements are generally arranged in a random manner, so as to disrupt any keylogger, in contrast to a basic virtual keypad of a mobile terminal 1, which has a predetermined fixed organization (for example that of the physical azerty keypad as explained), so that the user is easily able to use it. Step (a) thus comprises randomly arranging the elements of the virtual keypad in such a case.

As explained, the display functions of the graphical user interface 13 may be deactivated, this being called the “black screen” mode. In the embodiment in which the graphical user interface 13 is a touchscreen, the screen is quite simply inactive, with the touchpad operating normally. In the embodiment in which the computing equipment 1 is a computer, the screen/monitor is turned off, but the pointing device and keypad are on.

The black screen mode may either result from a security option in which the display is interrupted in order to avoid being looked at by others who are not of poor sight (provision may possibly also be made for the screen reading mode to activate this black screen mode), or else a simple wish to preserve the battery. Indeed, this changes absolutely nothing for a blind user.

In any case, it will be understood that, in such a black screen mode, only the execution of the display is not implemented, the processing operations implemented by the data processing module 11 (for example the random arrangement of the elements of the virtual keypad) and the entry remaining unchanged; even though it is not visible, the virtual keypad is still “present” and its keys are able to be selected (in the same way as it is still possible to use a mouse to click on an element without the screen lit up), even though the absence of feedback makes it particularly difficult to use a conventional control mode.

It will be noted that step (a) may also comprise, if the virtual keypad is displayed, displaying general information and/or buttons for implementing an entry in conventional mode, typically a confirm button (when the whole code has been entered) and a delete button (for going back). It will also be seen that some cells may be provided in order to indicate the number of elements in the code, and for example an asterisk is displayed at each selected element in the cell in order to indicate that the entry has taken place without otherwise disclosing the entered element.

### Screen Reading Mode

In a conventional control mode, the user enters said code by selecting (for example by pressing), in succession, the keys of the virtual keypad corresponding to the elements of the sequence forming said code.

For example, if the code is 1234, it consists of the sequence of numbers “1”, “2”, “3” and “4”, and the user therefore presses the keys “1”, “2”, “3” and “4” of the virtual keypad in succession.

As explained in the introduction, this becomes tedious in a screen reading mode, in particular if the elements of the keypad are arranged randomly and include dummy elements.

The present method cleverly proposes to present the content of the keypad vocally as a single block within which a plurality of entry actions are available. In other words, rather than having a “1” key, a “2” key, etc. whose position is difficult to ascertain, there is a single key that may be “1” or “2”, etc. A list of possible elements of said virtual keypad is defined for this purpose. One element from the list corresponds to one of the elements of the virtual keypad. This list is for example ordered so as to make it easier to read. In the case of an alphanumeric virtual keypad, provision may for example be made for the list to contain, in succession, the numbers from 0 to 9 and then the letters from A to Z. Depending on the elements contained in the keypad, any arrangement that makes sense to the user may be made.

In one particular embodiment, said list of possible elements of said virtual keypad comprises all of the elements of the virtual keypad that are able to form part of the code, but not the elements that cannot form part of the code, such as the dummy elements. Any dummy elements are thus not presented vocally and no longer hamper the user.

This list may be seen as a list of possible actions linked to the virtual keypad, the action associated with an element of the keypad being virtually that of pressing the key corresponding to this element. A current element from the list is then defined as the element that will be selected if the keypad “block” is called upon. The current element may be initialized arbitrarily as the first element from the list, or the last element selected for example.

It will be noted that, in order to facilitate the interaction of the user, said (ordered) list of possible elements of said virtual keypad may furthermore comprise a delete element, the selection of which causes a return to the previous element of the sequence forming the code (i.e. equivalent to the “delete” button that is seen in FIG. 2). Thus, if the current element is this delete action, selecting it deletes the selection of the last element of the code, and the previous step is returned to. If no element has yet been entered at this stage (i.e. the user is at the first element of the code), selecting the delete element will not do anything.

As will be seen later on, this makes the user's life far easier in comparison with currently known screen reading software that runs in a conventional entry mode, in which the user has to endlessly go back and forth between a delete key and the virtual keypad: he has no confirmation of executing the delete operation and, in order to ascertain where he is in terms of entering his code, he has to position himself on the cells marked with an asterisk at the bottom of his screen, and that is if he can even see them.

Moreover, as an alternative or in addition, the list may comprise a confirm element, the selection of which leads to the end of the entry and the submission of the obtained code. This is particularly advantageous in the case of a code whose length may be variable, i.e. which does not always contain the same number of elements.

This list may be predefined or generated at the end of step (a) in a manner conventional for a screen reader: this will simply read the whole keypad in one go, and not just the keys in succession.

In one particular embodiment, step (a) thus also comprises vocally describing, on the audio output 14, said list of possible elements of said virtual keypad, i.e. all of the elements are read.

It will be noted that this reading may follow that of instructions on the present use of the virtual keypad in order to explain for example to the user to connect a headset to the audio output 14 in order to maintain confidentiality, and then how he will be able to select each element of the code.

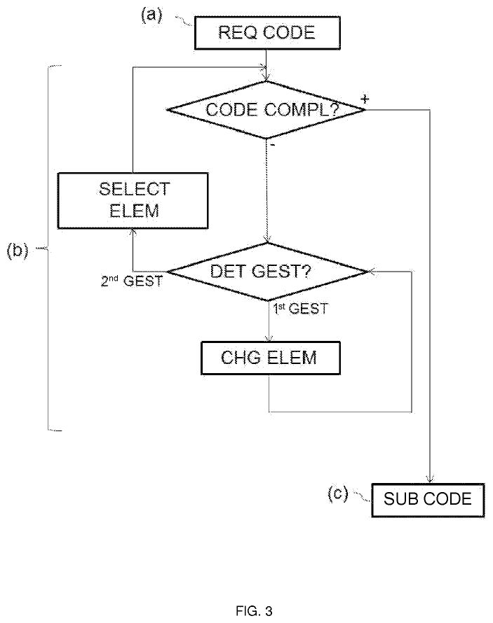

With reference to FIG. 3, in a step (b), the user uses the list to select each element of the sequence in an iterative manner: the elements of the sequence are selected and confirmed one by one until the code is complete, i.e. until the last element has been selected and confirmed and the user of the personal code has possibly been validated (see further below). It will therefore be understood that step (b) is implemented at least the same number of times as there are elements in the code (in one example described below, the number of elements in the code plus twice the number of deletions of elements).

The idea is that of having two types of gesture that may be performed on the graphical user interface 13, one (called gesture of a first type) making it possible to change the current element, i.e. to scroll through the list, with a view to selection and the other (called gesture of a second type) making it possible to confirm the current element as the following element of the sequence. It will be noted that there may additionally be a third type of gesture and/or a fourth type of gesture that are dedicated, respectively, to confirmation and deletion (if there are types of gesture defined for these actions, it is not mandatory for the list to comprise corresponding elements, and the list may where appropriate contain exclusively elements of the virtual keypad). These types of gesture do not rule out the possibility of even further types, such as a default type of gesture of the screen reading mode for reading a zone, or type of gesture for canceling the entire entry and exiting.

A gesture is understood to mean a characteristic movement performed by the user depending on the nature of the graphical user interface 13.

If this is a touchscreen, said first and second types of gesture are tapping gestures, using a finger or a stylus for example. The “default” gesture of the screen reading mode for reading a zone may conventionally be a single tap, i.e. a brief one without any movement, and the first and second types of gesture may be different taps, such as a swipe for the first type of gesture (that is to say a movement throughout the duration of the tap), and a double tap or a long tap (for a duration greater than a given threshold in order to differentiate between a single tap and a long tap) for the second type of gesture.

If the graphical user interface 13 is another technology, for example a screen/pointing device combination, the gestures may be movements of the pointer or pressing of certain buttons. Conventionally, the “default” gesture of the screen reading mode for reading a zone may be a left click, and the first and second types of gesture may be other actions, such as rotating a wheel for the first type (or scrolling) and a click tap or a left click for the second type.

It will be noted that there may be several gestures of a first type, corresponding for example to two directions of running through the list (i.e. two different gestures). For example, a swipe up may scroll through the list in one direction, such as in ascending order if it is ordered (the current element changes from “1”, to “2”, to “3”, etc.) and a swipe down may scroll through the list in the other direction, such as in descending order if it is ordered (the current element changes from “3”, to “2”, to “1”, etc.). The same thing is possible using the wheel for example. With regard to the third and fourth types of gesture, it is possible for example to adopt a swipe with a first form for the deletion and a swipe with a second form for the confirmation.

It will be noted that the list may loop around: if the current element is the last element and the first type of gesture continues to be performed, there is a return to the first element from the list (for example a swipe up changes from “9”, to “delete”, to “0” to “a”, etc.).

In one particular embodiment, each detection of a first or second type of gesture may be accompanied by the voice description, on the audio output 14, of the action implemented following this detection.

In other words, changing a current element from the list may be accompanied by a voice description, on the audio output 14, of the new current element (its value is typically simply spoken), the selection of the current element may be accompanied by a description of this selection (if for example “8” has just been selected as the third element of the code, then “8 is the third digit of the code, one more digit to be selected” may be spoken, or if the delete element has just been selected, then “third digit of the code deleted, please select the third digit again” may be spoken).

Once all of the elements of the code have been selected, the code is complete, and a final step (c) of submitting the code may be implemented, i.e. the input code is used, for example transmitted to the remote server 2 in order to authenticate the user. This submission may be performed in a conventional manner, in particular just the positions/references of the keys of the virtual keypad corresponding to the elements of the code may be transmitted, so as to maintain the additional security offered by an in particular randomized virtual keypad.

It will be noted that step (c) may be implemented directly as soon as the expected number of elements of the code have been entered, or preceded by validation by the user: indeed, the user might have made a mistake in selecting the last element. For this confirmation:
either the user performs the dedicated gesture (for example a second form, as explained above)
or the user selects the corresponding validation element from the list,
or the user is vocally offered a list dedicated to the confirmation and able to be used in the same way as the list in step (b), but not containing any element of the virtual keypad.

Such a confirmation list contains for example a delete element, a confirm element, and possibly an element for vocalizing the entire code. Navigation in this list may be in exactly the same way as in step (b), with a first type of gesture for changing current element and a second type of gesture for confirming the current element.

As another alternative, the confirmation may be decided after a certain time: if for example the user has not deleted the last element within 10 seconds, then it is considered that he agrees with the entry and it is confirmed.

The present development is not otherwise limited to any way of confirming the code.

In any case, the entire code may be vocalized automatically as soon as the last element is selected, so as to make it easier to verify.

### Example

A four-digit code 8547 will for example be assumed.

In step (a), the virtual keypad as shown in FIG. 2 is displayed, and this virtual keypad is described vocally, for example after the instructions have been spoken (identifier number of the user, number of elements of the code, explanation of the list, various gestures, etc.).

The user currently knows that the list contains eleven elements, namely the ordered numbers from “0” to “9” and the delete element.

In a first instance of step (b), said user scrolls through the list from “0” to “8” through a series of gestures of a first type (swipe up), the corresponding number being vocalized each time, and then he selects the element “8” through the gesture of a second type (double tap). “8 is the first digit, now select the second digit” is then spoken.

In a second instance of step (b), said user scrolls through the list from “8” to “5” through a series of gestures of a first type (swipe down this time), the corresponding number being vocalized each time, and then he selects the element “5” through the gesture of a second type (double tap). “5 is the second digit, now select the third digit” is then spoken.

In a third instance of step (b), said user scrolls through the list from “5” to “3” through a series of gestures of a first type (swipe down), the corresponding number being vocalized each time, and then he selects the element “3” through the gesture of a second type (double tap). “3 is the third digit, now select the fourth and final digit” is then spoken.

For example, the user identifies that he has made a mistake, and he has scrolled down one too many times because he should have chosen 4 rather than 3. Thus, in a fourth instance of step (b), said user scrolls through the list from “3” to the delete element through a series of gestures of a first type (swipe down), the corresponding number being vocalized each time (and “delete the last digit” is spoken when he reaches the delete element), and then he selects the delete element through the gesture of a second type (double tap). “The third digit has been deleted, now select the third digit again” is then spoken. It will therefore be seen that this deletion does not disrupt the entry at all since the user always knows where he is in the entry process.

In a fifth instance of step (b), said user scrolls through the list from the delete element to “4” through a series of gestures of a first type (swipe up), the corresponding number being vocalized each time, and then he selects the element “4” through the gesture of a second type (double tap). “4 is the third digit, now select the fourth and final digit” is then spoken.

In a sixth instance of step (b), said user scrolls through the list from “4” to “7” through a series of gestures of a first type (swipe up), the corresponding number being vocalized each time, and then he selects the element “7” through the gesture of a second type (double tap). “7 is the fourth and final digit, the entered code is 8547, do you wish to confirm?” is then spoken.

In this example, it is identified that there are four instances of step (b) corresponding to the four digits of the code, plus two instances of step (b) corresponding to deletion of a digit (deletion+reselection).

The user lastly performs the gesture of a third type (swipe right) to confirm, and the code 8547 is transmitted to the server 2 for authentication in step (c).

### Security Server and Computing Equipment

According to a second aspect, the development relates to the computing equipment 1 for implementing the method according to the first aspect.

As explained, this computing equipment 1 comprises a data processing module 11 and a graphical user interface 13. This is for example a touchscreen. The computing equipment 1 may furthermore comprise an audio output 14, a data storage module 12, a communication module, configured so as to be connected to a remote server 2, etc.

The data processing module 11 is thus configured so as to:
request that the user enter a code on the graphical user interface 13 by way of a virtual keypad, said code consisting of a sequence of elements of said virtual keypad (typically all of the elements of the keypad able to form part of the code and any dummy elements, and also possibly a delete element and/or a confirm element);
for an element of the sequence forming said code:
   either detect a first gesture performed by the user on the graphical user interface 13, and then change a current element from a list of possible elements of said virtual keypad;
   or detect a second gesture, different from the first gesture, performed by the user on the user interface 13, and then select the current element as the element of said sequence forming said code (if said element is the delete element, return to the selection of the previous element of the sequence forming the code);
where applicable, after each element of the code has been selected, submit the code.

More precisely, the virtual keypad comprises elements arranged in a random manner.

More precisely, an element from the list associated with the virtual keypad corresponds to one of the elements of the virtual keypad.

### Computer Program Product

According to a third and a fourth aspect, the development relates to a computer program product comprising code instructions for executing (in particular on the data processing module 11 of the computing equipment 1) a method according to the first aspect of the development for controlling a computing equipment 1, and storage media able to be read by a computing equipment (the data storage module 12 of the computing equipment 1) and on which this computer program product is located.

1. A method of controlling a computing equipment comprising a graphical user interface, the method comprising:
(a) requesting that the user enter a code on the graphical user interface by way of a virtual keypad, comprising elements arranged in a random manner, the code consisting of a sequence of elements of the virtual keypad;
(b) for an element of the sequence forming the code:
if a gesture of a first type performed by the user on the graphical user interface is detected, changing a current element from a list of possible elements associated with the virtual keypad corresponding respectively to one of the elements of the virtual keypad;
if a gesture of a second type, different from the first type of gesture, performed by the user on the user interface is detected, confirming the current element as the element of the sequence forming the code.

2. The method of claim 1, wherein the graphical interface is a touchscreen, the first and second types of gesture being tapping gestures.

3. The method of claim 2, wherein the first type of gesture is a swipe and the second type of gesture is a double tap.

4. The method of claim 1, wherein, with the computing equipment furthermore comprising an audio output, (b) comprises vocally describing, on the audio output, an action implemented following the detection of a gesture of the first or second type.

5. The method of claim 1, wherein (a) comprises vocally describing, on the audio output, the list of possible elements of the virtual keypad.

6. The method of claim 1, wherein the virtual keypad comprises at least one element that cannot form part of the code, the list of possible elements of the virtual keypad comprising all of the elements of the virtual keypad that are able to form part of the code.

7. The method of claim 1, wherein the list of possible elements of the virtual keypad furthermore comprises a delete element, confirmation of which causes a return to the previous element of the sequence forming the code.

8. The method of claim 1, furthermore comprising, after each element of the sequence forming the code has been selected, submitting the code.

9. A computing equipment comprising a data processing module and a graphical user interface, wherein the data processing module is configured to:
request that a user enter a code on the graphical user interface by way of a virtual keypad, comprising elements arranged in a random manner, the code consisting of a sequence of elements of the virtual keypad;
for an element of the sequence forming the code:
either detect a gesture of a first type performed by the user on the graphical user interface, and then change a current element from a list of possible elements of the virtual keypad, corresponding respectively to one of the elements of the virtual keypad; or
detect a gesture of a second type, different from the first type of gesture, performed by the user on the user interface, and then confirm the current element as the element of the sequence forming the code.

10. A computer comprising a processor and a memory, the memory storing code instructions of a computer program comprising code instructions to implement the method of claim 1 for controlling a computing equipment when the program is executed by the processor.

11. A non-transitory computer-readable storage medium comprising a computer program stored thereon and comprising code instructions for implementing the method of claim 1 for controlling a computing equipment.
